(19) United States
(12) Patent Application Publication
(10) Pub. No.: US 2005/0040369 A1
(43) Pub. Date: Feb. 24, 2005

(54) Thermal interface materials; and compositions comprising indium and zinc

(76) Inventors: John N. Lalena, Puyallup, WA (US); Nancy R. Dean, Liberty Lake, WA (US); Martin W. Weiser, Liberty Lake, WA (US)

Correspondence Address: Deborah Chess;Honeywell International Inc, 101 Columbia Road, Morristown, NJ, 07962, US

(21) Appl. No.: 10/502,480

(22) PCT Filed: Apr. 23, 2002
(86) PCT No.: PCT/US02/12821

(30) Foreign Application Priority Data
Jan. 30, 2002 (US) 60354051

(51) Int. Cl. H01B 1/00

(52) U.S. Cl. 252/500

(57) ABSTRACT

The invention includes a semiconductor package which comprises a semiconductor substrate and a heat spreader. A thermal interface material thermally connects the substrate to the heat spreader. The thermal interface material consists essentially of In, Zn, and one or more elements selected from the group consisting of Mg, Ca, Nb, Ta, B, Al, Ce, Ti and Zr. The invention also includes a composition consisting essentially of In and Zn. The Zn concentration within the composition is from about 0.5 weight % to about 3 weight %. The invention also includes a composition consisting essentially of In, Zn and one or more of Mg, Ca, Nb, Ta, B, Al, Ce, Ti and Zr.

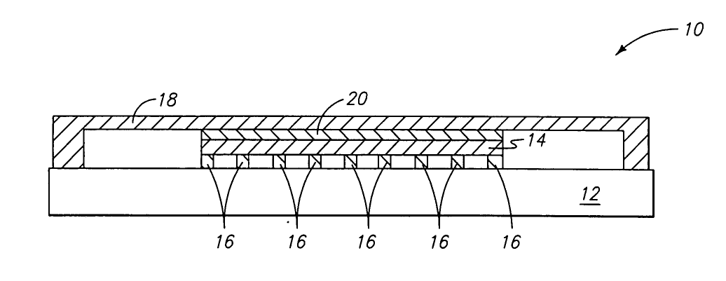

### TECHNICAL FIELD

The invention pertains to thermal interface materials, and in particular applications pertains to thermal interface materials comprising indium and zinc. The invention also pertains to compositions comprising indium and zinc. The invention can further pertain to methods of forming thermal interface materials.

### BACKGROUND OF THE INVENTION

Thermal interface materials (TIMs) have numerous applications for conducting heat to and/or from electrical components. One application of TIMs is to conduct heat away from semiconductor devices during operation of integrated circuitry associated with the devices.

It is desired to develop compositions which can be utilized for TIMs. It is also desired that the TIMs have high thermal conductivity for present and future semiconductor packages. It is further desired that the TIMs be suitable for utilization between a semiconductor device and a lid (heat spreader). Additionally, it is desired that the TIMs be suitable for bonding to a variety of surfaces and have a low modulus with high strength.

### SUMMARY OF THE INVENTION

In one aspect, the invention includes a semiconductor package. The package comprises a semiconductor substrate and a heat spreader proximate the substrate. A thermal interface material thermally connects the substrate to the heat spreader The thermal interface material consists essentially of In and Zn. Alternatively, the thermal interface material can consist essentially of In, Zn and one or more elements selected from the group consisting of Mg, Ca, Nb, Ta, B, Al, Ce, Ti and Zr. The Zn concentration within the material can be, for example, from about 0.5 weight % to about 3 weight %.

In one aspect, the invention includes a composition consisting essentially of In and Zn. The Zn concentration within the composition is from about 0.5 weight % to about 3 weight %. The invention also includes a composition consisting essentially of In, Zn and one or more of Mg, Ca, Nb, Ta, B, Al, Ce, Ti and Zr.

### BRIEF DESCRIPTION OF THE DRAWING

Preferred embodiments of the invention are described below with reference to the accompanying drawing. The drawing shows a diagrammatic cross-sectional view of a semiconductor package illustrating an exemplary aspect of the invention.

### DETAILED DESCRIPTION OF THE PREFERRED EMBODIMENTS

A composition formed in accordance with aspects of the present invention can be used to create all or part of a thermal interface material between a heat source and a heat sink, and/or a heat spreader. The thermal interface material can be considered to aid in transferring heat from one surface to another.

Compositions of the present invention can comprise, consist essentially of, or consist of In and Zn. Alternatively, compositions of the present invention can comprise, consist essentially of, or consist of In, Zn and one or more elements selected from the group consisting of Mg, Ca, Nb, Ta, B, Al, Ce, Ti and Zr. The Zn in various exemplary compositions can be present to a concentration of less than or equal to 3 weight %, and in particular compositions can be present to a concentration of less than or equal to about 2.2 weight %. If one or more elements selected from the group consisting of Mg, Ca, Nb, Ta, B, Al, Ce, Ti and Zr are present, the total concentration of such one or more elements can be less than or equal to 1000 ppm. In particular applications, the total concentration of the one or more elements selected from the group consisting of Mg, Ca, Nb, Ta, B, Al, Ce, Ti and Zr is less than or equal to 500 ppm, or even less than or equal to 200 ppm.

The elements incorporated with Zn and In in various TIM compositions of the present invention can, in particular aspects of the invention, be considered dopants which aid in bonding the TIM to a silicon nitride surface associated with a semiconductor die. Accordingly, it can be desirable to utilize dopants which improve interaction of In-Zn with such surface. From thermodynamic data, Mg, Ca, Nb, Ta, B, Al, Ce, Ti and Zr are identified as having more stable nitrides than silicon. This would indicate that they would tend to react with the silicon nitride and form a good bond. Mg was chosen for the examples that follow, as it forms a reaction product with silicon and does not form intermetallics with In or Zn which could embrittle solders comprising In and Zn. In various applications of the invention, one or more other elements selected from the group consisting of Ca, Nb, Ta, B, Al, Ce, Ti and Zr can be used in addition to, or alternatively to, Mg.

A particular material utilized in aspects of the present invention can have a composition which comprises, consists essentially of, or consists of: (1) less than or equal to 1000 ppm Mg (the effect of Mg seems to degrade in 1000 ppm tests, with a Mg concentration of from about 200 ppm to about 500 ppm appearing to be optimal in particular applications); (2) less than or equal to 3 weight % Zn (a range of from about 0.5 weight % to about 2.2 weight % Zn appears to be typically desirable, with 1 weight % Zn being preferable in particular applications); and (3) indium. The concentration of Zn can be, for example, within a range of from greater than 0 weight % to less than or equal to 3 weight %; in some applications within a range of from greater than 0 weight % to less than or equal to 2.5 weight %; in further applications within a range of from greater than 0 weight % to less than or equal to 2 weight %; in yet further applications within a range of from greater than 0 weight % to less than or equal to 1.5 weight %; and in yet further applications within a range of from greater than 0 weight % to less than or equal to 1 weight %. In various particular applications the concentration of Zn can be chosen to form a eutectic alloy with the In of a composition.

In one aspect of the invention, an In-based alloy comprising about 1 weight % Zn and less than or equal to about 1000 ppm Mg is produced. The alloy is found to wet and bond (adhere) well to silicon nitride coated substrates. Various components of the alloy can impact physical characteristics of the alloy. For instance, indium can provide a low modulus and high thermal conductivity; zinc can improve the alloy's high temperature corrosion resistance; and magnesium can improve wetting and bonding to silicon nitride.

The alloy comprising In, Zn and Mg can be formed by (1) mixing pieces of In, Zn and Mg metals in a graphite crucible; (2) melting the metals at a temperature of from about 150° C. to about 350° C. to form a molten mixture; (3) pouring the molten mixture into a mold of a desired shape; and (4) cooling the mixture within the mold to form a solid mass of the alloy having the desired shape. The mass can subsequently be rolled or extruded by conventional metal-working techniques to form ribbon or wire suitable for, for example, utilization as solder.

In particular aspects of the invention, alloys of indium having greater than 95 weight % indium (such as alloys having greater than 98 weight % indium, and in some applications greater than 99 weight % indium) have thermal conductivities close to that of pure indium (82 W/m*K). The alloys can consist of, or consist essentially of, for example, alloys of In and Zn which the concentration of Zn is from about 0.5 weight % to about 3 weight %. The indium of the alloys can enable the alloys to wet various surfaces. Wetting tests indicate that the alloys can have wetting forces approaching 500 microNewtons per millimeter on nickel. Zn can impart strength to the alloys, and can improve oxidation resistance of the alloys relative to the oxidation resistance of pure In.

Compositions of the present invention (such as In/Zn alloys) can be cast by conventional methods in air or under inert atmospheres. The metals can be melted together at, for example, about 450° C. during the casting. Slabs or billets can be produced by the casting. The slabs or billets can be further processed to form ribbon or wire of the alloy compositions. The ribbon or wire can subsequently be utilized as a solder to form TIMs in particular applications.

A “dry interface” or one with no interface material present, will typically only have actual contact over about 1% of the interface area due to microscopic (surface roughness) and macroscopic (surface warpage or non-planarity) irregularities of the mating components. The remainder of the dry interface area contains an “air gap” across which it is difficult to conduct heat. Introducing a thermal interface material into this air gap area can improve the transport of thermal energy (heat) from one component to another.

Thermal resistance typically measures thermal interface material performance. Thermal resistance is the temperature drop across the interface times the interface area divided by the power flowing through the interface (reported in units of ° C. cm²/W). The thermal resistance can be broken into three parts: (1) a contact resistance at the hot surface going into the interface material, (2) a bulk resistance due to thermal conduction through the interface material, and (3) a contact resistance at the interface material/cold surface junction. These are series resistances, which implies that all of them should be low to have a low overall thermal resistance.

The bulk thermal resistance is low when the interface material thermal conductivity is high. Accordingly, it is generally desired that an interface material have a high thermal conductivity. The thickness of an thermal interface material can also impact bulk thermal resistance, with thinner thermal interface materials having lower resistance than thicker materials. Accordingly, it is generally desired to use thin thermal interface materials.

The contact resistance between two contacting materials is preferably low. The contact resistance can be reduced if surfaces of the contacting materials interact with one another. For metallic materials, it is desired to have good wetting behavior (spreading of one material relative to another). To improve reliability over time (as opposed to right after the joint is formed), it is desirable to have a fair degree of mutual solubility, intermetallic, and/or compound production, any of which can promote good adherence/bonding at the interface between contacting materials. Alloying additions or dopants can aid in achieving one or more of the above-described desired properties between contacting materials.

### Compositions of Exemplary Samples of Material Formed in Accordance with Aspects of the Present Invention

### EXAMPLE 1

A composition consists essentially of or consists of: In, 1 weight % Zn, and 250 ppm Mg.

### EXAMPLE 2

A composition consists essentially of, or consists of: In, 1 weight % Zn, and 500 ppm Mg.

Materials encompassed by various aspects of the present invention can be used as, for example, free standing solder (applied in ribbon, wire or preform shapes), solder paste, anodes, evaporation slugs, or solder components of polymer-solder hybrid interface materials. A schematic illustrating a use of a thermal interface material comprising a composition formed in accordance with an aspect of the present invention is shown in the FIGURE. More specifically, the FIGURE shows an assembled electronic package 10 comprising a base 12 supporting a semiconductor substrate 14. Substrate 14 can comprise, for example, a silicon die. Base 12 can comprise electrical connections (not shown) utilized for connecting circuitry (not shown) associated with substrate 14 to devices external of package 10. Substrate 14 can be connected to the electrical connections of base 12 through flip chip bumps 16.

A heat spreader 18 is proximate substrate 14, and in the shown embodiment forms a lid of package 10.

A thermal interface material 20 is provided between heat spreader 18 and substrate 14. The thermal interface material thermally connects substrate 14 with heat spreader 18, and in the shown embodiment is physically against both substrate 14 and heat spreader 18. It is to be understood, however, that other embodiments (not shown) can be utilized in which thermal interface material 20 is separated from one or both of substrate 14 and heat spreader 18 by other materials. Preferably such other materials are thermally conductive to enable thermal energy to be transferred across the materials to and from the thermal interface material.

Thermal interface material 20 can comprise any of the various compositions of the invention discussed above, including, for example, compositions consisting essentially of In and Zn; as well as compositions consisting essentially of In, Zn and one or more of Mg, Ca, Nb, Ta, B, Al, Ce, Ti and Zr.

To aid in interpretation of the claims that follow, the terms “semiconductive substrate” and “semiconductor substrate” are defined to mean any construction comprising semiconductive material, including, but not limited to, bulk semiconductive materials such as a semiconductive wafer (either alone or in assemblies comprising other materials thereon), and semiconductive material layers (either alone or in assemblies comprising other materials). The term “substrate” refers to any supporting structure, including, but not limited to, the semiconductive substrates described above.

1. A composition consisting essentially of In and Zn; with the Zn concentration being from about 0.5 weight % to about 3 weight %.

2. The composition of claim 1 being in the shape of a billet.

3. The composition of claim 1 being in the shape of a ribbon.

4. The composition of claim 1 being in the shape of a wire.

5. A composition consisting essentially of In, Zn, and one or more elements selected from the group consisting of Mg, Ca, Nb, Ta, B, Al, Ce, Ti and Zr; with the Zn concentration being from about 0.5 weight % to about 3 weight %.

6. The composition of claim 5 being in the shape of a billet.

7. The composition of claim 5 being in the shape of a ribbon.

8. The composition of claim 5 being in the shape of a wire.

9. The composition of claim 5 wherein a total concentration of the one or more elements is greater than 0 ppm and less than or equal to 1000 ppm.

10. The composition of claim 5 wherein a total concentration of the one or more elements is greater than 0 ppm and less than or equal to 500 ppm.

11. The composition of claim 5 wherein a total concentration of the one or more elements is greater than 0 ppm and less than or equal to 200 ppm.

12. The composition of claim 5 comprising Mg to a concentration greater than 0 ppm and less than or equal to 1000 ppm.

13. The composition of claim 5 comprising Mg to a concentration greater than 0 ppm and less than or equal to 500 ppm.

14. The composition of claim 5 comprising Mg to a concentration greater than 0 ppm and less than or equal to 200 ppm.

15. A composition consisting essentially of In, greater than 0 weight % Zn and less than or equal to about 2 weight % Zn, and from greater than 0 ppm to less than or equal to about 500 ppm Mg.

16. The composition of claim 15 comprising less than or equal to about 250 ppm Mg.

17. The composition of claim 15 comprising less than or equal to about 1 weight % Zn.

18. The composition of claim 17 comprising less than or equal to about 250 ppm Mg.

19. A semiconductor package, comprising:
a semiconductor substrate:
a heat spreader proximate the substrate; and
a thermal interface material thermally connecting the substrate to the heat spreader; the thermal interface material consisting essentially of In and Zn; with the Zn concentration being from greater than 0 weight % to about 3 weight %.

20. The composition of claim 19 wherein the Zn concentration is from greater than 0 weight % to about 2 weight %.

21. The composition of claim 19 wherein the Zn concentration is from about 0.5 weight % to about 2.2 weight %.

22. The composition of claim 19 wherein the Zn concentration is from about 0.5 weight % to about 1 weight %.

23. A semiconductor package, comprising:
a semiconductor substrate:
a heat spreader proximate the substrate; and
a thermal interface material thermally connecting the substrate to the heat spreader; the thermal interface material consisting essentially of In, Zn, and one or more elements selected from the group consisting of Mg, Ca, Nb, Ta, B, Al, Ce, Ti and Zr; with the Zn concentration being from about 0.5 weight % to about 3 weight %.

24. The package of claim 23 wherein a total concentration of the one or more elements in the thermal interface material is greater than 0 ppm and less than or equal to 1000 ppm.

25. The package of claim 23 wherein a total concentration of the one or more elements in the thermal interface material is greater than 0 ppm and less than or equal to 500 ppm.

26. The package of claim 23 wherein a total concentration of the one or more elements in the thermal interface material is greater than 0 ppm and less than or equal to 200 ppm.

27. The package of claim 23 wherein the thermal interface material comprises Mg to a concentration greater than 0 ppm and less than or equal to 1000 ppm.

28. The package of claim 23 wherein the thermal interface material comprises Mg to a concentration greater than 0 ppm and less than or equal to 500 ppm.

29. The package of claim 23 wherein the thermal interface material comprises Mg to a concentration greater than 0 ppm and less than or equal to 200 ppm.

30. The package of claim 23 wherein the thermal interface material consists essentially of In, about 1 weight % Zn, and from greater than 0 ppm to less than or equal to about 500 ppm Mg.

31. The package of claim 23 wherein the thermal interface material consists essentially of In, about 1 weight % Zn, and from greater than 0 ppm to less than or equal to about 250 ppm Mg.
